(19) United States
(12) Patent Application Publication
(10) Pub. No.: US 2008/0007481 A1
(43) Pub. Date: Jan. 10, 2008

(54) Digital photo frame having dual display panels

(76) Inventors: Tain-Rein Chen, Hsinchu (TW); Chang-Liang Wang, Hsinchu (TW)

Correspondence Address: FRENKEL & ASSOCIATES, 3975 UNIVERSITY DR., STE. 330, FAIRFAX, VA, 22030, US

(21) Appl. No.: 11/483,062

(22) Filed: Jul. 6, 2006

(51) Int. Cl. G09G 5/00

(52) U.S. Cl. 345/1.1

(57) ABSTRACT

A digital photo frame having dual display panels of the present invention includes a frame body, a foot, a microprocessor, an output and input interface, an external connecting storage device, a multiplexer, a first buffer unit, a second buffer unit, a third buffer unit, a first display panel, a second display panel and a control panel. When a portrait mode photo is desired to be displayed, the microprocessor sends the photo to the first buffer and to display the photo in the first display panel. When a landscape mode photo is desired to be displayed, the microprocessor sends the photo to the second buffer and to display the photo in the second display panel. Hence the present invention can avoid incorrect display ratio of the photos.

### BACKGROUND OF THE INVENTION

1. Field of the Invention

The invention relates in general to a digital photo frame, and more particularly to a digital photo frame having dual display panels of landscape and portrait modes.

2. Description of the Related Art

Digital products are more and more popular nowadays. Many conventional devices are replaced by digitalized devices: a digital camera is a good example. However, while the digital camera becomes available to the consumers, the conventional way to develop photos and to display the photos on conventional photo frames is out of time. In addition, the conventional way to develop photos costs time and money to keep the photos.

Photos are normally developed in a rectangular frame. Landscape mode photos refer to the photos having a longer horizontal side than a vertical side. On the other hand, portrait mode photos refer to the photos having a smaller horizontal side than a vertical side. Since the landscape mode photos are very common, more landscape mode panels are manufactured than the portrait mode panels. However, when the portrait mode photos are displayed on the landscape mode panels, both regions of the photos show black and also the whole photo size becomes too small in order to fit the display panel of the digital photo frame. Hence the digital photo frame still can be further improved.

### SUMMARY OF THE INVENTION

The present invention provides a digital photo frame having dual display panels. In order to achieve the above objective, a main technique of the present invention includes a frame body, a foot, a microprocessor, an output and input interface, an external connecting storage device, a multiplexer, a first buffer unit, a second buffer unit, a third buffer unit, a first display panel, a second display panel and a control panel.

The microprocessor is configured inside the photo frame body. The output and input interface is coupled to the microprocessor for further coupling to the external connecting storage device. The multiplexer configured inside the frame body coupled to the microprocessor. The fist buffer unit and the second buffer unit are configured inside the frame body coupled to the multiplexer. The first display panel and the second display panel are configured next to each other on the front of the frame body that are respectively coupled to the first buffer unit and the second buffer unit. Furthermore, the first display panel is of a portrait mode rectangle and the second display panel is of a landscape mode rectangle.

When a portrait mode photo is desired to be displayed, the microprocessor sends the photo to the first buffer and to display the photo in the first display panel. When a landscape mode photo is desired to be displayed, the microprocessor sends the photo to the second buffer and to display the photo in the second display panel. Hence the present invention can avoid incorrect display ratio of the photos.

Moreover, a third buffer unit is further configured inside the photo frame body. The third buffer unit is coupled to the microprocessor for receiving and storing image files.

Further, a control panel is configured on the front of the frame body coupled to the microprocessor for controlling the microprocessor to make photos of the image files rotate for ninety degrees.

### BRIEF DESCRIPTION OF THE DRAWINGS

FIG. 1 is a perspective view of a preferred embodiment of a digital photo frame in accordance with the present invention;

FIG. 2 is a block diagram of the preferred embodiment of the digital photo frame in accordance with present invention;

FIG. 3 is a flow diagram of a preferred embodiment able to permanent display photos of the present invention; and

FIG. 4 is a work flow diagram of a preferred embodiment able to auto-circularly display photos of the present invention.

### DETAILED DESCRIPTION OF THE INVENTION

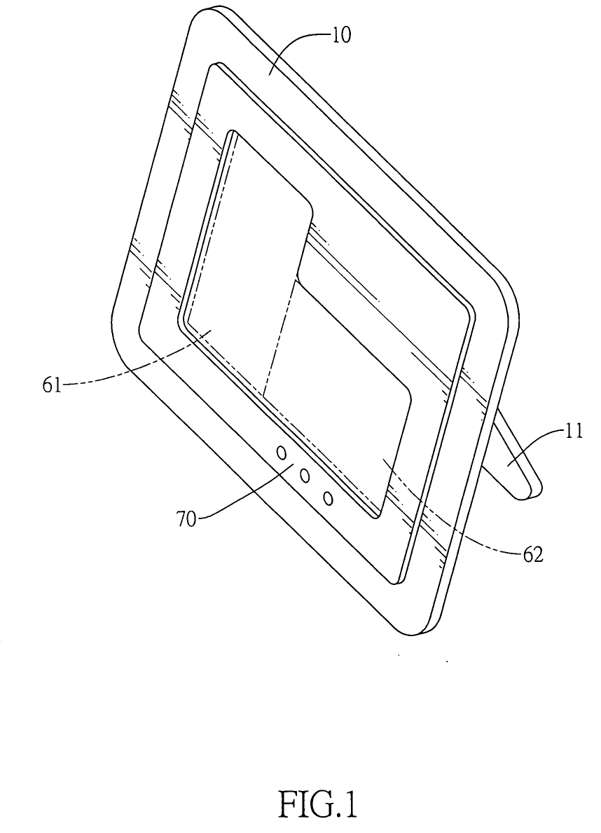

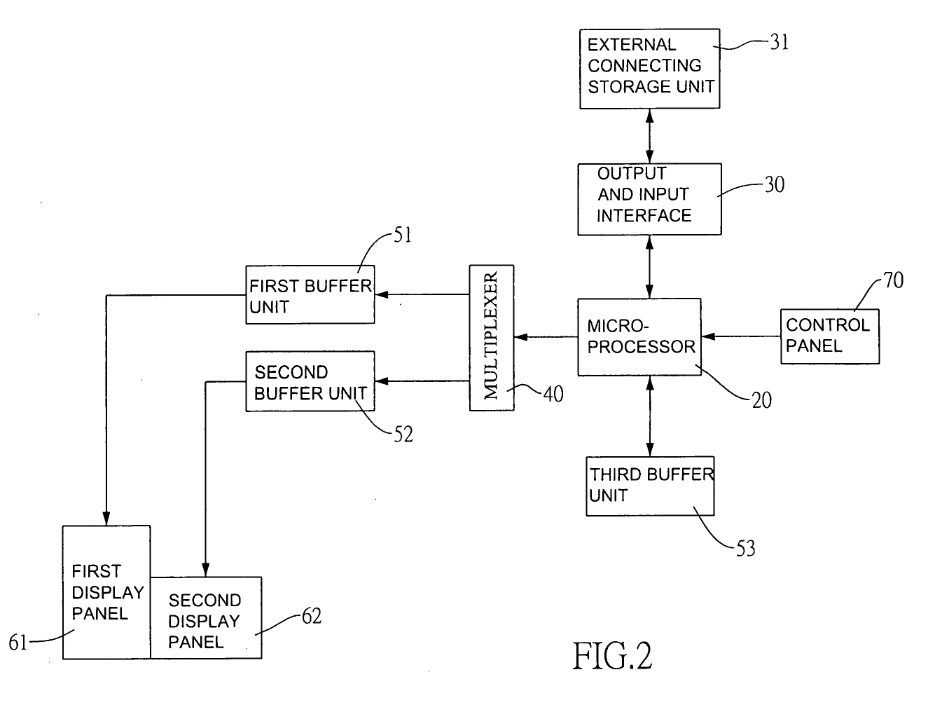

With reference to FIG. 1 and FIG. 2, a preferred embodiment of a digital photo frame having dual display panels of the present invention includes a frame body (10), a foot (11), a microprocessor (20), an output and input interface (30), an external connecting storage device (31), a multiplexer (40), a first buffer unit (51), a second buffer unit (52), a third buffer unit (53), a first display panel (61), a second display panel (62) and a control panel (70).

The frame body (10) is a rectangular frame structure with the foot (11) configured on the back of the frame body (10). The microprocessor (20) is configured inside the frame body (10). The output and input interface (30) is coupled to the microprocessor (20) for further coupling to the external connecting storage device (31) to read multiple image files stored in the external connecting storage device (31). In this preferred embodiment, the output and input interface (30) is a memory card connector interface, and the external connecting storage device (31) is a memory card.

The multiplexer (40) is configured inside the frame body (10) and coupled to the microprocessor (20). The fist, the second and the third buffer units (51, 52, and 53) are respectively configured inside the frame body (10). The first and the second buffer units (51 and 52) are coupled to the multiplexer (40), so that the microprocessor (20) controls to assign tasks to the first and the second buffer units (51 and 52) via the multiplexer (40). The third buffer unit (53) is coupled to the microprocessor (20) and used as a storage area for receiving and storing image files. The image files of the external connecting storage device (31) can be transferred to the third buffer unit (53). Hence the digital photo frame having dual display panels of the present invention still can display photos when the external connecting storage device (31) is disconnected.

The first display panel (61) and the second display panel (62) are configured next to each other on the front of the frame body (10) and respectively coupled to the first and the second buffer units (51 and 52). The first display panel (61) is of a portrait mode rectangle and the second display pane] (62) is of a landscape mode rectangle.

The control panel (70) is configured on the front of the frame body (10) and coupled to the microprocessor (20). The control panel (70) controls the microprocessor (20) to set a display time interval of the image files and a rotating direction (clockwise or counterclockwise for ninety degrees) and then the microprocessor (20) controls the third buffer unit (53) to storage the display time interval information and the rotating direction information. Therefore, the microprocessor (20) will control the image to display on the display panel (62) according to the display time interval information and the rotating direction information stored in the third buffer unit (53).

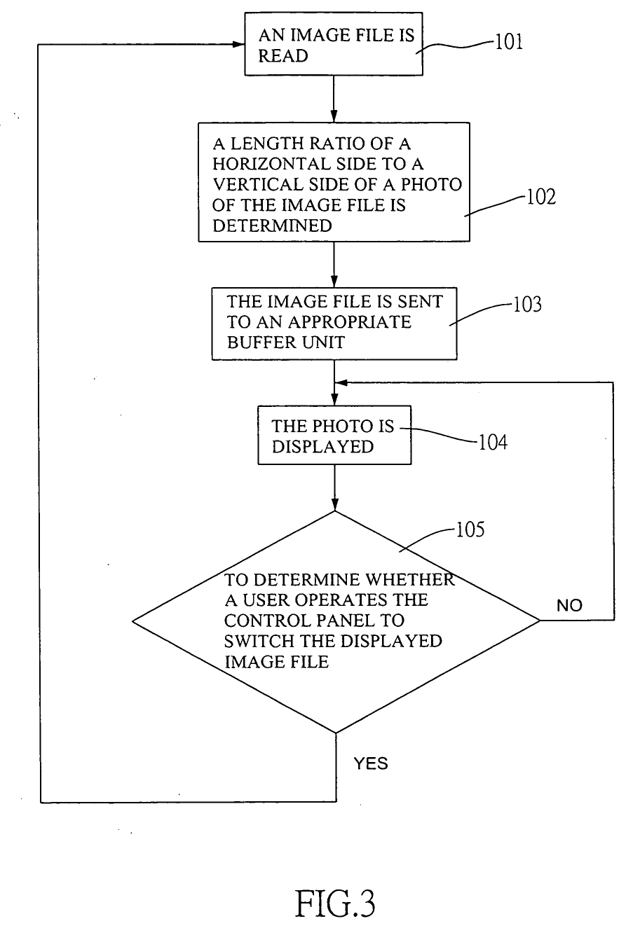

With reference to FIG. 2 and FIG. 3, a flow of the digital photo frame having dual display panels able to permanent display photos of the present invention includes steps as follows.

The microprocessor (20) reads an image file from the external connecting storage device (31) or the third buffer unit (53) in a step (101). The microprocessor (20) determines a length ratio of a horizontal side to a vertical side of a photo of the image file in a step (102), and then the image file is sent to an appropriate buffer unit in a step (103). If the photo of the image file is of portrait mode, the image file is set to the first buffer unit (11) On the other hand, if the photo of the image file is of landscape mode, the image file is sent to the second buffer unit (52).

Then the corresponding display panel of the buffer unit displays the photo in a step (104). In a step (105), if a user operates the control panel (70) to switch the displayed image file, the flow returns to an initial state of the step (101) that the microprocessor (20) reads another image file from the third buffer unit (53). On the other hand, if the user does not operate the control panel (70), the photo is still displayed as the step (105).

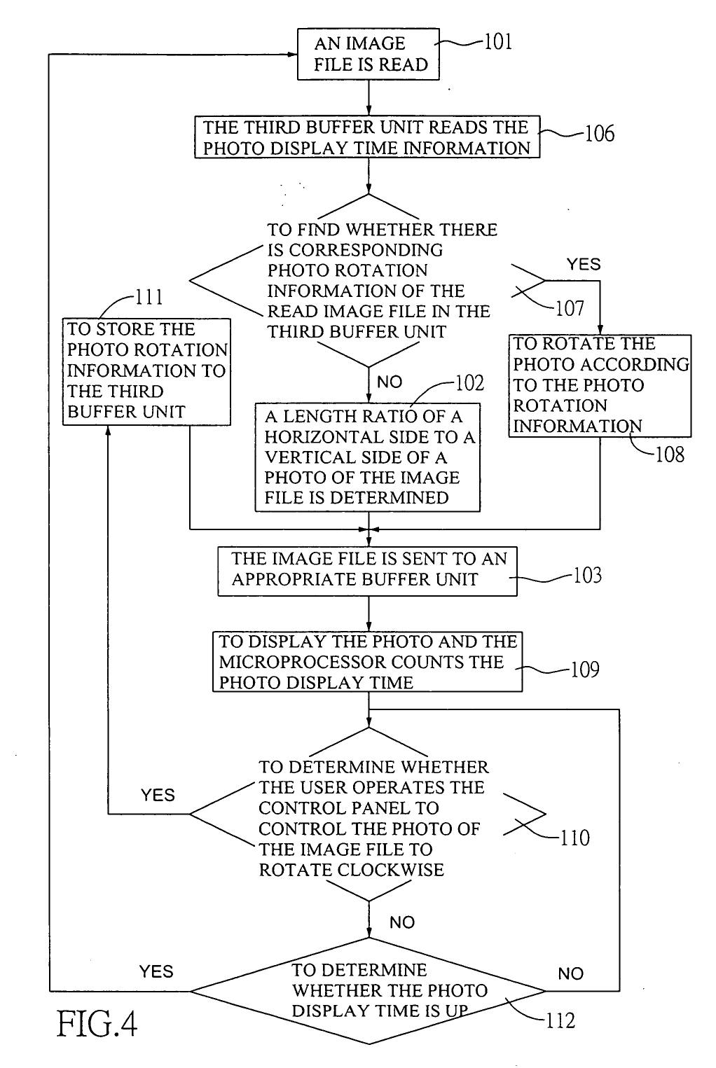

Further, with reference to FIG. 2 and FIG. 4, a work flow of a digital photo frame having dual display panels able to auto-circularly display photos of the present invention is approximately similar to the aforesaid example of the digital photo frame having dual display panels able to permanent display photos. The differences are as follows.

After the microprocessor (20) reads the image files in the step (101), the third buffer unit (53) reads the photo display time information in a step (106). Then the microprocessor (20) finds whether there is corresponding photo rotation information of the read image file in the third buffer unit (53) in a step (107). If there is no corresponding photo rotation information stored in the third buffer unit (53), the microprocessor (20) determines the length ratio of a horizontal side to a vertical side of the photo in the step (102), and then to send the image file to the appropriate buffer unit in the step (103). On the other hand, if the third buffer (53) stores the corresponding photo rotation information, the microprocessor (20) reads the photo rotation information from the third buffer unit (53) to rotate the photo accordingly in a step (108). Then the image file is sent to the appropriate buffer unit in the step (103).

Then the corresponding display panel of the buffer unit displays the photo and the microprocessor (20) counts the photo display time in a step (109). During a process of displaying the photo, the microprocessor (20) continues to determine whether the user operates the control panel (70) to control the photo of the image file to rotate clockwise or counterclockwise for ninety degrees in a step (110). If the user operates the control panel (70) to rotate the photo, the photo rotation information overwrites and stores to the third buffer unit (53) in a step (111), and also the image file is sent to the appropriate buffer unit in the step (103). On the other hand, if the user does not operate the control panel to rotate the photo, the photo is still displayed and also the counted display time of the microprocessor (20) is determined whether the photo display time is up in a step (112). If the display time of the photo is up, the work flow returns to an initial state of the step (101) to read another image file.

It can be clearly understood from the above description that the digital photo frame having dual display panels of the present invention can auto-select the appropriate display panel in accordance with the photo mode of the portrait mode or the landscape mode. Hence an issue of the conventional digital photo frame that photos are abnormally shrunk to is resolved. Therefore the digital photo frame having dual display panels of the present invention indeed includes features of good utility and unobviousness to meet the requirements of a patent.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A digital photo frame having dual display panels comprising:
a photo frame body;
a microprocessor configured inside the photo frame body;
an output and input interface coupled to the microprocessor and adapted to couple to an external connecting storage device;
a multiplexer configured inside the frame body and coupled to the microprocessor;
a first buffer unit and a second buffer unit configured inside the frame body and respectively coupled to the multiplexer; and
a first display panel and a second display panel configured next to each other on the front of the frame body and respectively coupled to the first buffer unit and the second buffer unit, wherein the first display panel is of a portrait mode rectangle and the second display panel is of a landscape mode rectangle.

2. The digital photo frame having dual display panels as claimed in claim 1, further comprising a third buffer unit configured inside the photo frame body and coupled to the microprocessor for receiving and storing image files.

3. The digital photo frame having dual display panels as claimed in claim 2, further comprising a control panel configured on the front of the frame body and coupled to the microprocessor for setting a display time interval of image files.

4. The digital photo frame having dual display panels as claimed in claim 3, wherein the microprocessor controls the third buffer unit to store the display time interval of image files.

5. The digital photo frame having dual display panels as claimed in claim 2, further comprising a control panel configured on the front of the frame body and coupled to the microprocessor for setting a rotating direction of displaying image files.

6. The digital photo frame having dual display panels as claimed in claim 5, wherein the microprocessor controls the third buffer unit to store the rotating direction.

7. The digital photo frame having dual display panels as claimed in claim 1, wherein the output and input interface is a memory card connector interface for coupling to a memory card type external connecting storage device.
